(19) United States
(12) Patent Application Publication
(10) Pub. No.: US 2025/0066554 A1
(43) Pub. Date: Feb. 27, 2025

(54) MOLDABLE SILICONE ELASTOMERS HAVING SELECTIVE PRIMERLESS ADHESION

(71) Applicant: Lord Corporation, Cary, NC (US)

(72) Inventors: Paul Wheeler, Erie, PA (US); James Halladay, Erie, PA (US); Rick Ziebell, Cerritos, CA (US); Ross Zambanini, Raleigh, NC (US)

(21) Appl. No.: 18/913,389

(22) Filed: Oct. 11, 2024

Related U.S. Application Data
(62) Division of application No. 17/441,562, filed on Sep. 21, 2021.
(60) Provisional application No. 62/823,102, filed on Mar. 25, 2019.

(51) Int. Cl. C08G 77/12; C08G 77/00; C08G 77/08; C09J 183/04

(52) U.S. Cl. CPC C08G 77/12; C08G 77/08; C08G 77/70; C09J 183/04

(57) ABSTRACT

A composition for use in modifying the adhesion properties of silicone rubber compositions is described. The composition comprises alkoxy silanes, such as alkoxy silanes further comprising additional chemical functional groups such as epoxides, esters, and anhydrides; diffusion promoters that are completely or partially immiscible in the silicone rubber composition being modified; and compounds that can balance the hydride content of the silicone rubber compositions being modified. Modified curable silicone rubber compositions and methods of modifying the adhesive properties of silicone rubber compositions are also described. In particular, use of the presently disclosed compositions can provide modified silicone rubber compositions having selective adhesion for surfaces comprising thermoplastic and thermoset polymers as compared to metal surfaces.

### CROSS-REFERENCE TO RELATED APPLICATIONS

This application is a divisional application of U.S. patent application Ser. No. 17/441,562, filed Sep. 21, 2021, herein incorporated by reference in its entirety, which is a national stage filing of International Application No. PCT/US2020/024584, filed Mar. 25, 2020, which claims the benefit of and priority to U.S. Provisional Patent Application Ser. No. 62/823, 102 filed Mar. 25, 2019, the disclosures of which are incorporated herein by reference in their entireties.

### TECHNICAL FIELD

An adhesion modifier for altering the adhesion properties of a silicone rubber composition is provided. Also provided are the modified silicone rubber compositions comprising the adhesion modifier and methods of using the adhesion modifier to modify adhesion properties. Also provided are the methods by which the adhesion modifier is administered into bulk silicone rubber compositions to impart selective adhesion.

### BACKGROUND

Moldable organopolysiloxane compositions are commonly known and used. They are referred to as silicone rubber in general that have three types; Liquid Silicone Rubber (LSR), High Consistency Silicone Rubber (HCR), and Room Temperature Vulcanized rubber (RTV). With all such silicone rubber types, low surface activity causes poor adhesion to thermoplastics. In co-molding, overmolding, or two component molding processes, it is desired to modify the silicone rubber composition to gain adhesion to certain substrates. This then creates a cured and bonded composite article of both silicone rubber and the substrate material. This is considered a “primerless” system of adhesion that is accomplished without needing to apply primers or adhesives to the substrate. Selective adhesion is necessary as the modified silicone rubber is often molded in a metal mold. Adhesion to metal surfaces of the mold poses a significant problem upon removal of the cured article. Therefore, the desire is to adhere selectively to the thermoplastic substrate more than to the metal surface of the mold.

Modification of a silicone rubber can negatively affect cure rheology and physical properties of the cured article. These modifications can adversely affect the functional performance of the cured composite article. Therefore, it is desired to balance the bond formation reactions in such a way that there is no appreciable change to cure or physical properties as compared to those of the unmodified silicone rubber formulation.

There are several pre-prepared adhesion products available on the market. Available from many silicone rubber suppliers, these products contain adhesion ingredients already mixed ex-situ into the silicone composition and sold as “primerless adhesion silicone”. It has been reported that these pre-prepared products have relatively short shelf-life as the bond formation additives are present and mixed with the curatives where chemical instability and premature reactions often occur. Reportedly, this can cause bond strength variability and issues with scorch safety (pre-cure). It is desired to create a compositional mixture that is added in-situ to a host silicone rubber just prior to curing thus maintaining the freshness of the chemistry and robustness in bonding. In-situ mixing also allows for concentration of bond formation reactives, which favors improved bond strength performance.

There is great utility in the development of a concentrated compositional mixture of select adhesive chemistry that when put into a solution, balances the bond formation reactives so as not to significantly affect the cure rheology and physical property performance of the host silicone rubber formulation. Furthermore, if this concentrated compositional mixture is a free-flowing liquid, it becomes optimal for pumping into a stream of LSR and thus creates a ready additive that can be added in-situ to the process of LSR Injection Molding.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

Provided in some embodiments is an adhesion modifier composition, comprising at least one alkoxy silane, at least one diffusion promoter, wherein said diffusion promoter is a polyphenylsiloxane that is completely or partially immiscible in dimethylsilicone, optionally wherein the at least one diffusion promoter comprises at least one functional diffusion promoter, wherein the functional diffusion promoter can be hydride-functional or hydride-terminated. In some embodiments, functional diffusion promoters do not necessarily need to be hydride-termination, particularly where hydride functionality throughout the polymer backbone is sufficient. Thus, as disclosed herein, the functional diffusion promoters are assumed to be hydride-functional, but where necessary can be hydride-terminated. In some embodiments, said functional diffusion promoter is a hydride-functional or hydride-terminated polyphenylsiloxane that is completely or partially immiscible in dimethylsilicone, and at least one cure modifier, wherein the at least one cure modifier is a compound comprising a —Si—H group. In some aspects, the at least one alkoxy silane is a trialkoxy silane and/or an alkoxy silane comprising an additional functional group selected from an epoxide, an ester, and an anhydride. In some embodiments, the at least one alkoxy silane includes at least one alkoxy silane further comprising a functional group selected from an ester of fumaric acid, an ester of succinic acid, and an anhydride of succinic acid. The at least one alkoxy silane can be selected from the group consisting of glycidoxypropyl trimethoxy silane, bis(3-trimethoxysilylpropyl) fumarate, and (3-triethoxysilyl)propylsuccinic anhydride. In some aspects, the adhesion modifier comprises at least two alkoxy silanes.

In some aspects, the at least one diffusion promoter is a hydride-functional methylphenylpolysiloxane selected from the group consisting of a hydride-functional polyphenylmethylsiloxane, a hydride-functional polydiphenylsiloxane, a hydride-functional polyphenyl(dimethylhydrosiloxy)-siloxane, and a hydride-functional (methylhydrosiloxane)-phenymethylsiloxane copolymer. In some embodiments, the at least one cure modifier is selected from the group consisting of a hydride Q resin, a hydride-functional polydimethyl siloxane and a hydride-functional (dimethylsiloxane)-phenylmethylsiloxane copolymer.

In some embodiments, the composition comprises between about 15% by weight to about 50% by weight of the at least one functional silane, between about 19% by weight and about 70% by weight of the at least one diffusion promoter, and between about 15% by weight and about 45% by weight of the at least one cure modifier. In some aspects, the adhesion modifier composition can further comprise a transesterification catalyst, optionally a zinc-containing transesterification catalyst, further optionally wherein the transesterification catalyst comprises about 1% by weight of the total adhesion modifier composition further optionally wherein the transesterification catalyst comprises a titanium alkoxide. In some aspects, the adhesion modifier composition can further comprise one or more additional components, optionally selected from a polydimethylsiloxane and a silica.

Also provided herein are modified curable silicone rubber compositions comprising a curable organopolysiloxane composition that can be cured to provide a silicone rubber, and an adhesion modifier composition as disclosed herein. The curable organopolysiloxane composition can in some aspects be a composition that can be heat cured to provide a liquid silicone rubber (LSR), a high consistency rubber (HCR), or a room temperature vulcanized (RTV) silicone. The curable organopolysiloxane composition can comprise (i) an organopolysiloxane polymer having a viscosity of about 1,000 to about 10,000,000 centipoises at 25° C. and comprising silicon-bonded alkyl substituents having reactivity with an organohydrogenpolysiloxane crosslinker, optionally wherein the silicon-bonded alkyl groups are silicon-bonded vinyl groups, (ii) about 0.3 to about 40 parts by weight of the organohydrogenpolysiloxane crosslinker containing at least two silicon-bonded hydrogens per molecule, (iii) a catalytically effective amount of a platinum group metal catalyst, and (iv) about 0.01 to about 3 parts by weight of a cure inhibitor, optionally wherein the cure inhibitor is an acetylene alcohol derivative. In some aspects, the modified silicone rubber composition comprises between about 0.05% by weight and about 20% by weight of the adhesion modifier composition, optionally between about 0.25% by weight and about 2.0% by weight of the adhesion modifier composition.

In some embodiments, provided herein are methods of modifying the adhesion properties of a silicone rubber composition, wherein the method comprises mixing a curable organopolysiloxane composition with an adhesion modifier composition as disclosed herein to provide a modified curable silicone rubber composition. In some aspects, the mixing comprises adding between about 0.05% by weight and about 20% by weight of the adhesion modifier composition. In some embodiments, the curable organopolysiloxane composition is a composition that can be heat cured to provide a liquid silicone rubber (LSR), a high consistency rubber (HCR), or a room temperature vulcanized (RTV) silicone. The mixing can be performed in-situ during or just prior to a molding or extrusion process, optionally by pumping, injecting or intermixing a separate stream of the adhesion modifier composition into the curable organopolysiloxane composition just prior to curing (commonly referred to as ‘third-streaming’). In some aspects, modifying the adhesion properties can comprise increasing the adhesiveness of the corresponding cured silicone composition to a surface comprising a rigid thermoplastic, a thermoplastic elastomer, or a thermoset polymer and/or decreasing the adhesiveness of the corresponding cured silicone composition to a metal surface. In some aspects, the methods can further comprise curing the modified curable silicone composition to provide a cured silicone rubber. In some embodiments, curing the modified curable silicone composition comprises applying the modified silicone composition to a thermoplastic or thermoset polymer substrate and applying heat to cure the curable modified silicone composition. In some aspects, the cure time and state of cure of the cured silicone rubber are substantially the same as that of a cured silicone rubber prepared from the curable organopolysiloxane composition in the absence of the adhesion modifier composition. In some aspects, one or more of the physical properties of the cured cured silicone rubber are substantially the same as that of a cured silicone rubber prepared from the curable organopolysiloxane composition in the absence of the adhesion modifier composition.

Also provided herein are composites prepared according to the methods disclosed herein, comprising a silicone rubber component adhered to a thermoplastic or thermoset polymer substrate in the absence of a separate adhesive. In some aspects, provided herein are kits comprising, for example, a curable organopolysiloxane composition that can be cured to provide a silicone rubber, and an adhesion modifier composition as disclosed herein, wherein the curable organopolysiloxane composition or components thereof and the adhesion modifier composition or components thereof are provided in separate, sealable containers. In some embodiments, curable organopolysiloxane composition, the at least one alkoxy silane of the adhesion modifier composition, the at least one diffusion promoter of the adhesion modifier composition, and the at least one cure modifier of the adhesion modifier composition are each provided in a separate, sealable container.

Accordingly, it is an object of the presently disclosed subject matter to provide an adhesion modifier composition, modified silicone compositions comprising the adhesion modifier compositions and related methods. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following drawings in which:

FIG. 1 is a graph showing the bonding performance (on a scale from 0 to 10) of a liquid silicone rubber (LSR) modified with an adhesion modifier composition of the presently disclosed subject matter adhered to polybutylene terephthalate (PBT), polyamide 6 (PA6) or polyamide 66 (PA66).

FIG. 2 is a graph showing the rubber retention (as a percentage (%)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 3 is a graph showing the rubber retention (as a percentage (%)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 4 is a graph showing the rubber retention (as a percentage (%)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 5 is a graph showing the peel strength (measured in pounds per inch (lbs/in)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 6 is a graph showing the peel strength (measured in pounds per inch (lbs/in)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 7 is a graph showing the peel strength (measured in pounds per inch (lbs/in)) of a liquid silicone rubber (LSR) modified with 0.5 weight % or 1 weight % of an adhesion modifier composition of the presently disclosed subject matter adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 8 is a graph showing the rubber retention (as a percentage (%)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 9 is a graph showing the rubber retention (as a percentage (%)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory | conditions (primary), hot air (150 C), or 85 degrees Celsius (° C.) at 85% relative humidity (RH).

FIG. 10 is a graph showing the rubber retention (as a percentage (%)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 11 is a graph showing the peel strength (measured in pounds per linear inch (PLI)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 12 is a graph showing the peel strength (measured in pounds per linear inch (PLI)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 13 is a graph showing the peel strength (measured in pounds per linear inch (PLI)) of a liquid silicone rubber (LSR) modified with 0.5 weight % or 1 weight % of an adhesion modifier composition of the presently disclosed subject matter comprising a succinic anhydride group-containing trialkoxy silane and adhered to a polybutylene terephthalate (PBT; Lupox GP2300) or a polyamide (AKULON™ K224-HG6) substrate with or without post cure baking and after three days under three different aging conditions: laboratory conditions (primary), hot air (150 C), or 85 degrees Celsius (° C.) at 85% relative humidity (RH).

FIG. 14 is a graph showing the cure rheology (for six minutes at 165 degrees Celsius (° C.)) of a liquid silicone rubber (LSR) modified with 1 weight % of one of two different adhesion modifier compositions of the presently disclosed subject matter. For comparison, the results from the unmodified LSR are also shown.

FIG. 15 is a graph showing the cure rheology (for six minutes at 150 degrees Celsius (° C.)) of a liquid silicone rubber (LSR) modified with 1 weight % of one of two different adhesion modifier compositions of the presently disclosed subject matter. For comparison, the results from the unmodified LSR are also shown.

FIG. 16 is a graph showing the cure rheology (for six minutes at 150 degrees Celsius (° C.)) of a liquid silicone rubber (LSR) modified with 1 weight % of one of two different adhesion modifier compositions of the presently disclosed subject matter. For comparison, the results from the unmodified LSR are also shown.

FIG. 17 is a graph showing the cure rheology (for six minutes at 150 degrees Celsius (° C.)) of a liquid silicone rubber (LSR) modified with 1 weight % of one of two different adhesion modifier compositions of the presently disclosed subject matter. For comparison, the results from the unmodified LSR are also shown.

FIG. 18 is a graph showing the cure rheology (for six minutes at 149 degrees Celsius (° C.)) of a liquid silicone rubber (LSR) modified with 0.25weight % (wt %), 0.5 wt %, 1.0 wt %, or 2.0 wt % of an adhesion modifier composition of the presently disclosed subject matter. For comparison, the results of an unmodified LSR are also shown.

FIG. 19 is a graph showing the cure rheology (for six minutes at 149 degrees Celsius (° C.)) of a liquid silicone rubber (LSR) modified with 0.25 weight % (wt %), 0.5 wt %, 1.0 wt %, or 2.0 wt % of an adhesion modifier composition of the presently disclosed subject matter. For comparison, the results of an unmodified LSR are also shown.

FIG. 20 is a graph showing the cure rheology (for six minutes at 149 degrees Celsius (° C.)) of a liquid silicone rubber (LSR) modified with 0.25 weight % (wt %), 0.5 wt %, 1.0 wt %, or 2.0 wt % of an adhesion modifier composition of the presently disclosed subject matter. For comparison, the results of an unmodified LSR are also shown.

FIG. 21 is a graph showing the cure rheology (for six minutes at 149 degrees Celsius (° C.)) of a liquid silicone rubber (LSR) modified with 0.25 weight % (wt %), 0.5 wt %, 1.0 wt %, or 2.0 wt % of an adhesion modifier composition of the presently disclosed subject matter. For comparison, the results of an unmodified LSR are also shown.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a silane” includes a plurality of such silanes, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein the term “alkyl” refers to C₁₋₂₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. In some embodiments, there can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

“Alkoxyl” refers to an alkyl-O— group wherein alkyl is as previously described. The term “alkoxyl” as used herein can refer to, for example, methoxyl, ethoxyl, propoxyl, isopropoxyl, butoxyl, t-butoxyl, and pentoxyl. The terms “alkoxy” and “oxyalkyl” can be used interchangably with “alkoxyl”.

The term “silyl” refers to groups comprising silicon atoms (Si).

The term “silane” refers to a molecule comprising a silicone atom.

As used herein, the terms “siloxy” and “silyl ether” refer to groups or compounds including a silicon-oxygen (Si—OR) bond and wherein R is an organic group, such as a substituted or unsubstituted alkyl or aryl group (i.e., methyl, ethyl, phenyl, etc.). In some embodiments, the terms refer to compounds comprising one, two, three, or four alkoxy, aralkoxy, or aryloxy groups bonded to a silicon atom. Each alkyloxy, aralkoxy, or aryloxy group can be the same or different.

The terms “alkoxysilane” and “alkoxysilyl” refer to groups or compounds comprising a —Si—O—R group, wherein R is a substituted or unsubstituted alkyl group. In some embodiments, R is a C₁-C₆ alkyl group. In some embodiments, R is methyl or ethyl. In some embodiments, the alkoxysilane is a compound comprising more than one —O—R group covalently bonded to the same silicon atom. For example, a trialkoxysilane is a compound comprising the group —Si—(OR)₃, wherein each R is a substituted or unsubstituted alkyl group.

The terms “siloxane” and “organosiloxane” can refer to a molecule having a —Si—O—Si— group. In an organosiloxane, the silicon atoms are further bonded to carbon-containing groups, e.g., alkyl, aralkyl or aryl groups.

In some embodiments, the organosiloxane is a “polyorganosiloxane”, which refers to a polymer comprising the formula —[Si(R₁)(R₂)O]ₙ— wherein R₁ and R₂ are organic groups (e.g., alkyl, aryl, aralkyl, substituted alkyl or aryl, etc.) that can be the same or different. Thus, a polyorganosiloxane can comprise a backbone of alternating covalently bonded silicon and oxygen atoms, wherein the silicon atoms are further substituted by, for example, substituted or unsubstituted alkyl, aryl, or aralkyl groups.

The term “silicone rubber” as used herein refers to an elastomeric three-dimensional, cross-linked polysiloxane network or a composition that can be cured to provide the silicone rubber.

The term “curable silicone rubber” as used herein refers more particularly to a composition comprising a polyorganosiloxane that can be cured (e.g., via cross-linking) to form an elastomeric, three-dimensional, cross-linked silicone network. In some embodiments, the curing is performed by heating the curable silicone rubber.

‘The term “hydride-functional” refers to a silicon-hydride functional group located anywhere within the polymer chain, including the chain ends, within the backbone, on a side chain, or any combination of these.

### II. General Considerations

The presently disclosed subject matter provides, in some embodiments, a mixture (i.e., an “adhesion modifier”) for modifying a host silicone rubber formulation and a method for promoting migration of the bond formation reactives while maintaining cure rheology and the cured physical properties of the host. A concentrate of the adhesion modifier can be added to a curable silicone rubber formulation (i.e., a “host silicone rubber”), such as a commercially available silicone rubber formulation or other silicone rubber formulation known in the art, to modify it for select adhesion to a thermoplastic or thermoset polymeric substrate. The concentrated adhesion modifier, in liquid form, can be readily mixed into the host silicone rubber in-situ to form a modified curable silicone rubber and then cured. In some embodiments, the modified curable silicone rubber cures as intended (e.g., using the same conditions as the comparable unmodified curable silicone rubber composition) and exhibits physical and dynamic properties virtually unchanged from the unmodified silicone rubber formulation.

In some embodiments, the presently disclosed subject matter provides an adhesion modifier comprising an alkoxy silane, optionally further functionalized with an additional functional group that can interact (covalently or non-covalently) with groups on a plastic substrate. For example, the additional functional groups can be groups that can react with amino groups or carboxylic acid groups. The additional functional groups can also include groups that can hydrogen bond with groups in a plastic substrate. In some embodiments, the additional functional group is an epoxide, an ester, or an anhydride. Thus, for example, the alkoxy silane can be a compound such as, but not limited to, an alkoxysilyl-substituted epoxide or an alkoxysilyl-substituted fumarate or succinate, dissolved in a compatible carrier fluid that, when mixed into an uncured host silicone rubber, reacts in-situ to promote select adhesion of the mixture upon curing. In some embodiments, the siloxy fumarates and/or succinates in the mixture can be reacted through transesterification using compounds that activate upon mixing with the host silicone rubber.

The host silicone rubber can be of the following types: heat cured Liquid Silicone Rubber (LSR), High Consistency Rubber (HCR), or Room Temperature Vulcanized (RTV) silicone. In some embodiments, the adhesion modifier is added to the host silicone rubber at levels greater than about 0.05% by weight but less than about 20% by weight. In some embodiments, the adhesion modifier is added to the host silicone rubber at a level of between about 0.1% by weight and about 10% by weight or between about 0.1% by weight and about 5% by weight. In some embodiments, the adhesion modifier is added to the host silicone rubber at a level between about 0.25% by weight and about 2.0% by weight (e.g., at about 0.25, 0.30, 0.35, 0.40, 0.45, 0.50, 0.55, 0.60, 0.65, 0.70, 0.75, 0.80, 0.85, 0.90, 0.95, 1.0, 1.1, 1.2, 1.3, 1.4, 1.5, 1.6, 1.7, 1.8, 1.9, or about 2.0% by weight). In some embodiments, the adhesion modifier is added to the host silicone rubber at a level of between about 0.5% by weight and about 1.0% by weight.

In some embodiments, addition of the adhesion modifier modifies the host silicone rubber's chemical behavior to achieve “select adhesion” to substrates made from rigid thermoplastics, thermoplastic elastomers, and other thermoset resins and elastomers in solid, rigid, semirigid, soft, flexible, sheet form, molded form, tape, or fabric. Thus, once modified with the presently disclosed adhesion modifier, the host silicone formulation becomes a selective adhesion silicone to these substrates, while giving selective release characteristics to metal surfaces, used in the process of co-molding, overmolding, or two component (2K) molding. The selective nature of the system is optimized when the choice of the carrier fluid in the adhesion modifier is a phenylmethylpolysiloxane, which are completely or partially immiscible in the host silicone rubber and readily migrate to the surface during the molding process creating a semi-permeant release coating. The adhesion modifier can also be used to modify a host silicone rubber formulation for coating, calendering, and extrusion process to gain selective adhesion to substrates (as detailed above) and other polymer layers.

In some embodiments, the adhesion modifier further comprises specific diffusion promoters that promote the migration of bond formation reactives. The adhesion modifier can be made to include diffusion promoters that are tailored to rapidly migrate to the bond interface with the substrate during curing and create covalent bonds between the silicone rubber's own polymers, fillers, resins, crosslinkers, and the substrate's polymers and fillers. Rapid migration concentrates the bond formation reactives at this interface. Functional hydride-functional methylphenylsiloxane polymers and copolymers when dosed into the modifier and allowed to react, aid the diffusional migration of reactants to the bond interface with the substrate thus making the bond formation strong and more fast acting. Molding and curing times of the host silicone rubber are not impacted and are cured as intended.

In some embodiments, maintainance of both the physical and the dynamic properties of the host silicone rubber formulation is accomplished by balancing the bonding and curing reactive ingredients of the adhesion modifier. Curing with heat through hydrosilylation occurs by platinum cure (or addition cure) forming crosslinks across organosiloxane polymers having unsaturated (e.g., pendant vinyl) substituents along the polymer chain. The bond formation reactives can imbalance the intended ratio of the hydride content to pendant vinyl in the host silicone formulation. An imbalance can affect hydrosilylation efficiency which is apparent in changes in cure rheology and cured physical properties. The adhesion modifier can contain functional silanes, such as alkoxysilane, optionally alkoxysilyl-substituted epoxide, fumarates and/or succinates, as indicated hereinabove, and these can cause the imbalance. The adhesion modifier can then contain additional hydride content to stoichiometrically rebalance the hydrosilylation reactants. In some embodiments, the mixture can be dosed with a hydride Q resin and/or one or more hydride-functional polydimethyl siloxane or hydride-functional (dimethylsiloxane)-phenylmethylsiloxane copolymer. Therefore, the presently disclosed subject matter provides selective adhesion and also cure balance, thus maintaining key functional, physical, and dynamic properties of a silicone rubber, such as, but not limited to, tensile strength, elongation, resilience, heat aged compression set, and other properties.

Preferably, combining the various aspects of the presently disclosed subject matter allows the creation of a unique, select adhesion modifier, which, when incorporated into a host silicone rubber formulation, can be used to mold, extrude, or calendar bond composites without the need for using a primer or adhesive that is applied by physical means (such as spraying, brushing, or dipping) onto the substrate surface. Additionally, the presently disclosed subject matter modifies the host silicone rubber for selective adhesion to a substrate while maintaining its translucent nature, electrical properties, and inherent resistance to weather and sunlight.

In some embodiments, the adhesion modifier is of low viscosity, making it a pumpable homogeneous mixture that can be mixed into the uncured host silicone rubber formulation in an injection molded process. This can be accomplished by 3^{rd} stream pumping and dosing the select adhesion modifier into the LSR feed as it enters the static mixer just before the screw and barrel. Mixing in an in-situ manner maintains freshness as the modified silicone rubber is molded quickly into a composite article. Because the adhesive package does not preferentially bond to metals, it can be used with standard injection, compression, or transfer molds and tooling without special release surfaces applied to the cavities, valves, sprues, gates, or runners of the mold.

### III. Adhesion Modifier Composition

In some embodiments, the presently disclosed subject matter provides an adhesion modifier composition for use in modifying silicone rubber. In some embodiments, the composition comprises the following components:
(A) at least one alkoxy silane;
(B) at least one diffusion promoter, wherein said diffusion promoter is a polysiloxane (e.g., a polyphenylmethylsiloxane) that is completely or partially immiscible in dimethylsilicone; and
(C) at least one cure modifier, wherein the at least one cure modifier is a material comprising a —Si—H group.

In some embodiments, the alkoxy silane is a trialkoxy silane, such as a trimethoxy silane or a triethoxy silane. As described above, in some embodiments, the alkoxy silane further comprises an additional functional group that can interact with groups on a plastic substrate. Thus, in some embodiments, the alkoxy silane further comprises a group such as, but not limited to, an epoxide, an ester, or an anhydride. In some embodiments, the ester is an ester of fumaric acid, succinic acid, or maleic acid. In some embodiments, the anhydride is succinic anhydride. In some embodiments, the at least one alkoxy silane comprises an ester or an anhydride group.

In some embodiments, the at least one alkoxy silane comprises at least one of the group comprising glycidoxypropyl trimethoxy silane, bis(3-trimethoxysilylpropyl) fumarate, and (3-triethoxysilyl)propyl succinic anhydride. See Table 1, below, fourth, fifth and sixth entries. In some embodiments, the at least one alkoxy silane includes at least two alkoxy silanes. In some embodiments, the at least one alkoxy silane includes at least two alkoxy silanes further comprising an additional functional group. In some embodiments, the at least one alkoxy silane includes bis(3-trimethoxysilylpropyl) fumarate and/or (3-triethoxysilyl)propyl succinic anhydride.

In some embodiments, the diffusion promoter comprises a polyphenylmethyl siloxane, such as, but not limited to a silicone fluid sold under the tradename DOWSIL™ (Dow Corning Corporation, Midland, Michigan, United States of America), including DOWSIL™ 510, 550, 702, and 710 Fluids. See Table 1, below, last entry. In some embodiments, the diffusion promoter comprises at least one functional diffusion promoter, a dimethylsilicone insoluble polysiloxane (such as a polysiloxane comprising aryl-substituted silicon atoms) further comprising a group that can bond to a plastic substrate. In some embodiments, the functional diffusion promoter comprises a —Si—H group. In some embodiments, the functional diffusion promoter is a hydride-functional polyphenylmethylsiloxane that is completely or partially immiscible in dimethylsilicone. In some embodiments, the at least one diffusion promoter is a hydride-functional methylphenylpolysiloxane selected from the group consisting of a hydride-functional polyphenylmethylsiloxane, a hydride-functional polydiphenylsiloxane, a hydride-functional polyphenyl(dimethyl-hydrosiloxy)siloxane, and a hydride-functional (methylhydrosiloxane)-phenymethylsiloxane copolymer. See Table 1, below, first, second and third entries. In some embodiments, the adhesion modifier includes two or more diffusion promoters.

In some embodiments, the at least one cure modifier comprises a —Si—H group-containing resin. In some embodiments, the at least one cure modifier comprises a polysiloxane. In some embodiments, the polysiloxane cure modifier is soluble in dimethyl silicone. In some embodiments, the at least one cure modifier comprises a hydride Q resin (see Table 1, below, seventh entry) and/or hydride-functional polydimethyl siloxane and/or a hydride-functional (dimethylsiloxane)-phenylmethylsiloxane copolymer. Thus, in some embodiments, the cure modifier can also act as a diffusion promoter.

In some embodiments, the adhesion modifier composition comprises between about 15% by weight to about 50% by weight of the at least one alkoxy silane, between about 19% by weight and about 70% by weight of the at least one diffusion promoter, and between about 15% by weight and about 45% by weight of the at least one cure modifier. In some embodiments, the adhesion modifier comprises between about 25% and about 50% by weight of an alkoxy silane or a mixture of alkoxy silanes (e.g., about 25, 26, 28, 30, 32, 34, 36, 38, 40, 42, 44, 46, 48, or about 50% by weight). In some embodiments, the adhesion modifier comprises between about 30% and about 45% by weight of the alkoxy silane or mixture of alkoxy silanes (e.g., about 30, 32, 34, 36, 38, 40, 42, 44, or about 45% by weight). In some embodiments, the adhesion promoter comprises between about 39% and about 70% by weight of the at least one diffusion promoter (e.g., about 39, 40, 42, 44, 46, 48, 50, 52, 54, 56, 58, 60, 62, 64, 66, 68 or about 70% by weight). In some embodiments, the adhesion promoter comprises at between about 10% and about 25% by weight of at least one cure modifier (e.g., about 10, 11, 12, 13, 14, 15, 16, 17, 18, 19, 20, 21, 22, 23, 24, or about 25% by weight). In some embodiments, the cure modifier is a hydride Q resin.

In some embodiments, the adhesion modifier can include one or more additional components. In some embodiments, the adhesion modifier can further include a transesterification catalyst. For instance, in some embodiments, the transesterification catalyst is a metal catalyst. In some embodiments, the transesterification catalyst comprises zinc. In some embodiments, the transesterification catalyst can comprise titanium alkoxides, including but not limited to titanium ethoxide, titanium butoxide, titanium isopropoxide and titanium ethylhexoxide. In some embodiments, the adhesion modifier comprises between about 0.01% and about 3% by weight of the transesterification catalyst (e.g., about 0.01, 0.05, 0.1, 0.2, 0.4, 0.6, 0.8, 1.0, 1.2, 1.4, 1.6, 1.8, 2.0, 2.2, 2.4, 2.6, 2.8 or about 3% by weight). In some embodiments, the adhesion modifier comprises about 1% by weight of the transesterification catalyst. In some embodiments, the adhesion modifier can further include another additive, such as a polydimethylsiloxane fluid or a silica.

TABLE 1
Exemplary Components of the Adhesion Modifier

| | Trade | |
|---|---|---|
| Additive Description | Name | Purpose |
| Polyphenylmethylsiloxane, Hydride terminated 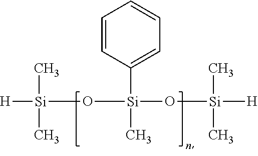 | HF2080 (SiSiB) | Completely or partially immiscible in dimethylsilicone, rapidly migrates to surface. Provides functional groups for bonding to silicone and functional silanes. |
| Polyphenyl-(dimethylhydrosiloxy)siloxane, hydride terminated 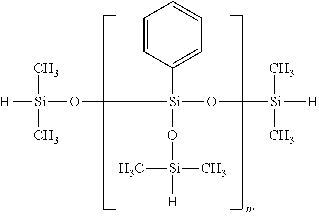 | HF2078 (SiSiB) | Completely or partially immiscible in dimethylsilicone, rapidly migrates to surface. Provides Si—H functional groups for bonding to silicone and functional silanes. |
| (45-50% methylhydrosiloxane)-phenylmethylsiloxane copolymer, hydride terminated 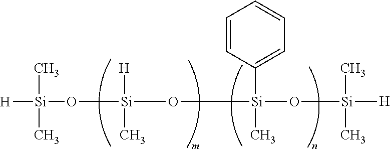 | HPM-502 (Gelest) | Completely or partially immiscible in dimethylsilicone, rapidly migrates to surface. Provides Si—H functional groups for bonding to silicone and functional silanes. |
| Glycidoxypropyl trimethoxy silane 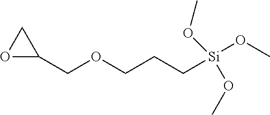 | A187 (Momen- tive) | Reacts to plastic functional groups (amines and acids) through glycidal group. Hydrolyzes over time and crosslinks with other additive |
| | | components as |
| | | well as substrate. |
| Bis (3-trimethoxysilylpropyl) fumarate 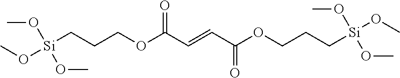 | SIB1834.5 (Gelest) | Hydrogen-bonds through ester groups with plastic. Dipodal functionality hydrolyzes over time and |
| | | crosslinks with |
| | | other additive |
| | | components as |
| | | well as substrate. |
| (3-triethoxysilyl) propylsuccinic anhydride 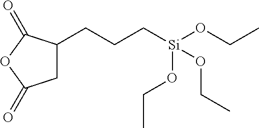 [SMILES: CCO[Si](CCCC1CC(=O)OC1=O)(OCC)OCC] | SIT8192.6 (Gelest) | Reacts to plastic functional groups (amines and acids) through anhydride group. Hydrolyzes over time and crosslinks with other additive components as |
| | | well as substrate. |
| Hydride Q resin 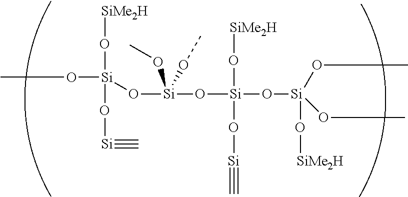 | MQH-9 (Milliken) | Used to balance physical properties, curing kinetics, and curing rheology of silicone. Provides additional Si—H functionality for bonding to substrates. |
| Proprietary compound | KKat 670 | Transesterification |
| | (King | and hydrolysis |
| | Industries) | catalyst used to |
| | | cure alkoxy |
| | | silanes. |
| Polyphenylmethylsiloxane (PPMS) 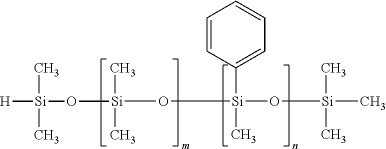 | 510, 550, 702, 710 Fluids (Dowsil) | Completely or partially immiscible in dimethylsilicone, rapidly migrates to surface. |
| Titanium Alkoxides 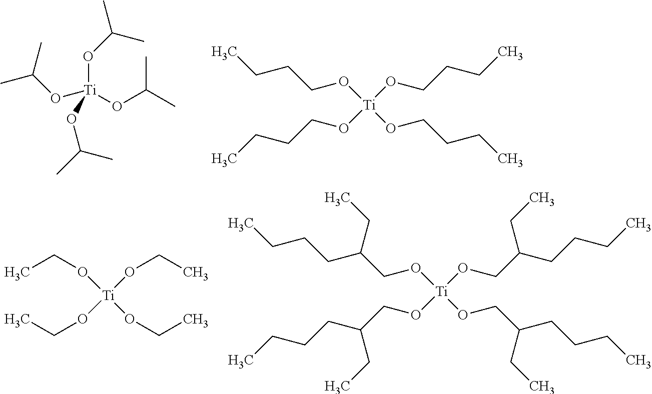 | | Transesterification and hydrolysis catalysts used to cure alkoxy silanes. |

### IV. Description of Host Silicone Rubber

The host silicone rubber composition to be modified according to the presently disclosed subject matter can comprise any suitable curable organopolysiloxane composition, e.g., a LSR, HCR, or RTV. Curable organopolysiloxane compositions that can be cured to provide silicone rubber are well known in the art and many are commercially available. In some embodiments, the host silicone rubber can be cured using a platinum-group catalyst, a peroxide, a tin catalyst, or an alkoxy. In some embodiments, the host silicone rubber composition comprises an organopolysiloxane composition that can be cross-linked and cured via hydrosilation reactions. In some embodiments, the curable organopolysiloxane composition can include the following components:
(A) an organopolysiloxane polymer; wherein there is up to 100 parts by weight of the organopolysiloxane polymer having a viscosity of about 1,000 to about 10,000,000 centipoises at 25° C. with unsaturated substituents (e.g., pendant vinyl groups), or mixtures of such organopolysiloxane polymers to provide functional reactivity with a crosslinker organohydrogenpolysiloxane;
(B) an organohydrogenpolysiloxane crosslinker; wherein there is from 0.3 to 40 parts by weight of the organohydrogenpolysiloxane crosslinker containing at least two silicon-bonded hydrogens per molecule;
(C) a platinum group metal catalyst; wherein there is a catalytically effective amount of the platinum group metal catalyst; and
(D) a cure inhibitor; wherein there is from 0.01 to 3 parts by weight of the cure inhibitor of a type of acetylene alcohol derivative.

In some embodiments, the curable organopolysiloxane composition can further include one or more fillers, plasticizers and/or other ingredients, such as but not limited to, viscosity modifiers, heat stability agents, and pigments, as typically used in the art.

In some embodiments, the organopolysiloxane polymer can contain at least 2 alkenyl groups (e.g., vinyl, allyl, butenyl, pentenyl, cyclohexenyl, or hexenyl) per molecule. In some embodiments, the organopolysiloxane polymer comprises at least 2 vinyl groups per molecule. The alkenyl groups can be on any siloxy unit in the organopolysiloxane (e.g., pendant or terminal). The organopolysiloxane polymer can be linear or branched. The organopolysiloxane polymer can be a single polymer or a combination of two or more different polymers. Examples of suitable organopolysiloxane polymers include, but are not limited to, vinyldimethylsiloxy-endblocked dimethylsiloxane-vinylmethylsiloxane copolymer, vinyldimethylsiloxy-endblocked polydimethylsiloxane, vinylmethylhydroxysiloxy-endblocked dimethylsiloxane-vinylmethylsiloxane copolymer, methylvinylcyclosiloxane and mixtures thereof.

Component B can include compounds comprising siloxy units substituted by hydrogen, alkyl, aralkyl, or aryl groups.

Any suitable platinum group metal catalyst can be used. Suitable platinum group metal catalysts can include any platinum group metal, e.g., platinum ruthenium, rhodium, palladium, osmium or iridium. Preferably, a transition metal-based catalyst can be synthesized from platinic chloride and chloroplatinic acid, to form platinum divinyl tetramethyldisiloxane complexes. These are known as Karstedt catalyst complexes such as those commercially available and referenced in literature as platinum⁽⁰⁾-1,3-divinyl, 1,1,3,3-tetramethyldisiloxane and platinum⁽⁰⁾-2,4,6,8-tetramethyl-2,4,6,8-tetravinylcyclotetrasiloxane complex. In some embodiments, the catalyst comprises platinum. The platinum-containing metal catalysts can include platinum metal, platinum compounds and platinum complexes. Representative platinum compounds and complexes include chloroplatinic acid, chloroplatinic acid hexahydrate, platinum dichloride, and complexes of such compounds containing low molecular weight vinyl containing organosiloxanes. Additional platinum-containing metal catalysts include platinum black, platinum supported on a carrier, chloroplatinic acid olefin complexes, and chloroplatinic acid-diketon complexes.

The cure inhibitor can be an acetylenic alcohol where an unsaturated bond group is in a terminal position and where a methyl or aromatic group can be at the alpha position. Suitable cure inhibitors include, but are not limited to, 1-ethylynyl-1-cyclohexanol, 2-methyl-3-butyn-2-ol, 3-butyn-1-ol, 3-butyn-2-ol, propargylalchol, 2-phenyl-2-propyn-1-ol and mixtures thereof. In some embodiments, the cure inhibitor is an ethynyl cyclohexanol or pyridine alcohol.

In some embodiments, the composition can include a filler, such as, but not limited to, silica, crushed quartz, diatomaceous earths, barium sulphate, iron oxide, titanium dioxide and carbon black, talc, and/or wollastonite. Heat stabilizers can include iron oxides and carbon blacks, iron carboxylate salts, cerium hydrate, barium zirconate, titania, cerium and zirconium octoates, and porphyrins.

In some embodiments, the presently disclosed subject matter provides a modified host silicone rubber (i.e., a modified curable silicone rubber composition) wherein a curable organopolysiloxane composition as described above is mixed with an adhesion modifier composition of the presently disclosed subject matter. In some embodiments, the resulting modified curable silicone rubber composition comprises between about 0.05% by weight and about 20% by weight of the adhesion modifier composition. In some embodiments, the resulting modified curable silicone rubber composition comprises between about 0.25% by weight and about 2.0% by weight of the adhesion modifier composition (e.g., about 0.25, 0.5, 0.75, 1.0, 1.25, 1.5, 1.75, or about 2.0% by weight of the adhesion modifier composition). The amount of adhesion modifier composition mixed into the host silicone rubber can be varied depending upon the particular composition of the modifier composition, the host silicone rubber composition and/or the desired properties of the cured silicone produced from the modified curable silicone rubber composition.

In some embodiments, the adhesion modifier is provided in a separate container from the host silicone rubber formulation and can be added to the host silicone rubber formulation just prior to curing. In some embodiments, one or more of the components of the adhesion modifier (e.g., the at least one alkoxy silane, the at least one diffusion promoter, and/or the at least one cure modifier) are each provided in separate, sealable containers and are mixed and/or added separately to the host silicone rubber formulation just prior to curing (e.g., about a few seconds or minutes prior to curing). In some embodiments, the components of the adhesion modifier are added separately or as a mixture to the host silicone rubber formulation less than about 2 hours prior to curing (e.g., less than about 1 hour, less than about 30 minutes, less than about 20 minutes, less than about 15 minutes, less than about 10 minutes, less than about 5 minutes, less than about 2 minutes, or less than about 1 minute prior to initiation of a curing process). For example, the adhesion modifier or components thereof can be added via pumping, injecting, or intermixing a separate stream or streams into the host silicone rubber formulation just prior to curing. Thus, for example, the modified curable silicone rubber composition can be prepared in-situ, e.g., during or just prior to a molding or extrusion process.

In some embodiments, the cure time and/or state of cure of the cured modified silicone rubber is substantially the same as the cured unmodified silicone rubber (e.g., varies by less than about 5, 4, 3, 2, or 1% or less from the cure time and/or state of cure of the cured unmodified silicone rubber). In some embodiments, one or more of the physical properties (e.g., the durometer, tensile strength, elongation, modulus, compression set, tear, etc.) of the cured modified silicone rubber are substantially the same as the cured unmodified silicone rubber. For example, the value of one or more of the physical properties of the cured modified silicone rubber can be within about 30%, about 25%, about 20%, about 15%, about 10% or about 5% or the value of the physical property of the cured unmodified silicone rubber.

### V. Description of Thermoplastic Substrate Types

In some embodiments, the resin substrates to which the select adhesion modified LSR, HCR, or RTV can be bonded include, but are not limited to, polyamides, such as polyamide 6, polyamide 66, polyamide 11, polyamide 12, and polyphthalamide (PPA); polyesters, such as polybutylene terephthalate (PBT) and polyethylene terephthalate (PET); polyphenylene ether, polyarylketones, polyetherimide, and polyimide. In some embodiments, the resin substrates can be glass filled, mineral filled, or carbon filled. Further, thermoset resins such as epoxy, silicone, or others that are manufactured by coating a substrate or by direct casting can be bonded to the cured modified organopolysiloxane composition. In some embodiments, the resin substrate is poly(butyl acrylate) (PBA) or polybutylene terephthalate (PBT).

In some embodiments, a modified curable silicone rubber composition is applied to the surface of a resin substrate and cured, thereby provided a composite article comprising a cured silicone rubber adhered to the surface of a thermoplastic or thermoset polymer substrate in the absence of a separate adhesive.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

The adhesion modifier compositions described below in Table 2 were mixed into an LSR from Dow (i.e., XIAMETER™ 2004-50; Dow Corning Corporation, Midland, Michigan, United States of America), at a 1% level. Mixing was accomplished on a Thinky centrifugal mixer (Thinky Corporation, Tokyo, Japan). After mixing, uncured silicone was placed, using a wooden spatula, on a plastic coupon, which was a 30% glass filled polyamide 66 (PA66; i.e., VYDYNE™ R530H BK02, from Ascend Performance Materials, LLC; Houston, Texas, United States of America). The coupons were then cured in a convection oven at 150° C. for 60 minutes. After curing, the silicone was peeled by hand and adhesion was given a subjective ranking between 1 to 10, with 1 being no adhesion and 10 being 100% rubber adhesion. The results show that a combination of phenyl hydride resin, epoxy silane, and fumarate silane give the best adhesion result. See Table 2, below.

TABLE 2
Formulas for Adhesion Modifier
Composition and Bonding Performance Results.

| | | Epoxy | Fumarate | Bonding |
|---|---|---|---|---|
| Code | HPM502 | Silane | Silane | Performance |
| 813-3 | 100% | | | 2 |
| 813-4 | 50% | 50% | | 8 |
| 813-5 | 50% | | 50% | 6 |
| 813-6 | 50% | 25% | 25% | 10 |
| 815-1 | | 100% | | 5 |

### Example 2

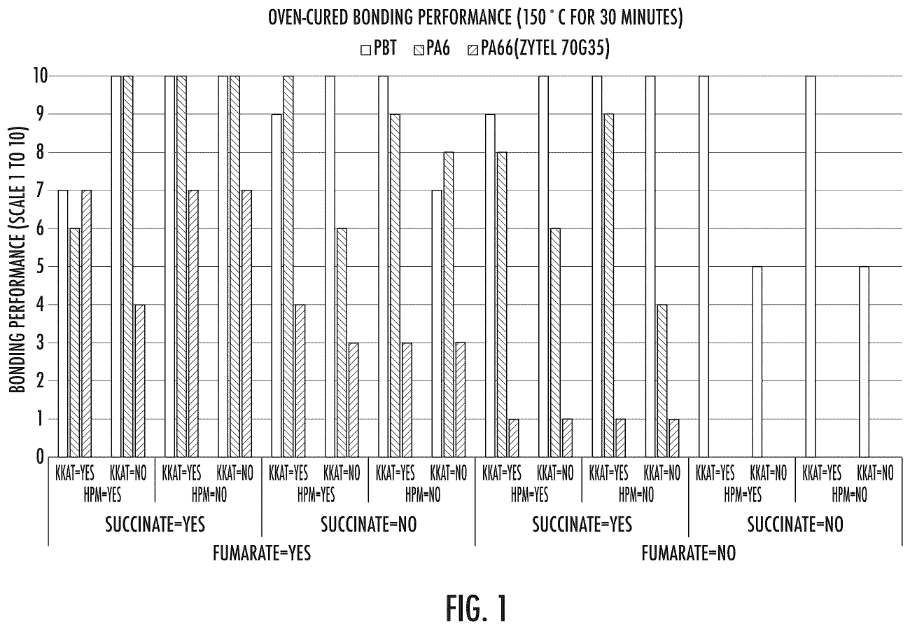

The adhesion modifier formulas described below in Table 3 were mixed into an LSR from Momentive (i.e., SILOPREN™ 2660; Momentive, Waterford, New York, United States of America) at a 1% level. Mixing was accomplished on a Thinky centrifugal mixer (Thinky Corporation, Tokyo, Japan). After mixing, uncured silicone was placed, using a wooden spatula, on a plastic coupon. The plastics tested were a 30% glass filled PBT (i.e., Lupox® GP2300, produced by LG Chemical, Seoul, Souther Korea), a 30% glass filled polyamide 6 (PA6, i.e., AKULON™ K224-HG6, produced by DSM, Heerlen, The Netherlands), and a 35% glass filled PA66 (i.e., ZYTEL™ 70G35HSLR, produced by DuPont, Wilmington, Delaware, United States of America). The coupons were then cured in a convection oven at 150° C. for 30 minutes. After curing, the silicone was peeled by hand and adhesion was given a subjective ranking between 1 to 10, with 1 being no adhesion and 10 being 100% rubber adhesion. The results show that fumarate silane and succinic silane dramatically improve adhesion to the plastics tested. See FIG. 1. Incorporation of a transesterification catalyst also improves bonding in many cases.

TABLE 3
Adhesive Modifier Compositions.

| | SiSiB | | | | | | |
|---|---|---|---|---|---|---|---|
| | HF | | MQH-9 | Fumarate | Succinic | | Kkat |
| Name | 2078 | A187 | Resin | Silane | Silane | HPM-502 | 670 |
| 1024-1 | 19% | 15% | 15% | 15% | 15% | 20% | 1% |
| 1024-2 | 20% | 15% | 15% | 15% | 15% | 20% | |
| 1024-3 | 39% | 15% | 15% | 15% | 15% | | 1% |
| 1024-4 | 40% | 15% | 15% | 15% | 15% | | |
| 1024-5 | 34% | 15% | 15% | 15% | | 20% | 1% |
| 1024-6 | 35% | 15% | 15% | 15% | | 20% | |
| 1024-7 | 54% | 15% | 15% | 15% | | | 1% |
| 1024-8 | 55% | 15% | 15% | 15% | | | |
| 1024-9 | 34% | 15% | 15% | | 15% | 20% | 1% |
| 1024-10 | 35% | 15% | 15% | | 15% | 20% | |
| 1024-11 | 54% | 15% | 15% | | 15% | | 1% |
| 1024-12 | 55% | 15% | 15% | | 15% | | |
| 1024-13 | 49% | 15% | 15% | | | 20% | 1% |
| 1024-14 | 50% | 15% | 15% | | | 20% | |
| 1024-15 | 69% | 15% | 15% | | | | 1% |
| 1024-16 | 70% | 15% | 15% | | | | |

The bonding data shown in FIG. 1 was done with platinum (addition) cured silicone, however this technology can also work in peroxide-cured silicone, tin, and alkoxy cures.

### Example 3

### Injection Molding Examples

The additional examples given below show bonding performance in injection molded, platinum cured liquid silicone rubber (LSR) materials.

### Molding Details:

All samples reported were produced via injection molding using a Wittmann Battenfeld EcoPower 110 toggle machine (Wittmann, Vienna, Austria) equipped with a Graco fluid pumping unit (Graco Inc., Minneapolis, Minnesota, United States of America). The silicones used consist of two-part systems that are mixed at a 1:1 ratio. The mixing occurs in a static mixer that is positioned on the feed section of the injection molding machine. Once mixed, the silicone will cure when heated. The adhesion modifier, a liquid mixture, was added via a pneumatic pump at immediately prior to the static mixer. This is the same approach used to add liquid colorants to silicone. Typical molding conditions are below:
Mold temperature=150° C.
Cure time=60 seconds
Fill time=1 to 6 seconds
Hold pressure=700 to 1200 PSI

Test specimens for a 90° peel test were prepared with a 107 mm long, 3.00 mm thick “dog bone” pad of the LSR adhered to a 60 mm long, 25 mm wide, 3.0 mm thick substrate. The substrate was centered along the length of the LSR, providing LSR overhang at both ends of the specimen. The width of the LSR varied from 13 mm in the area contacting the substrate to about 25 mm at the ends.

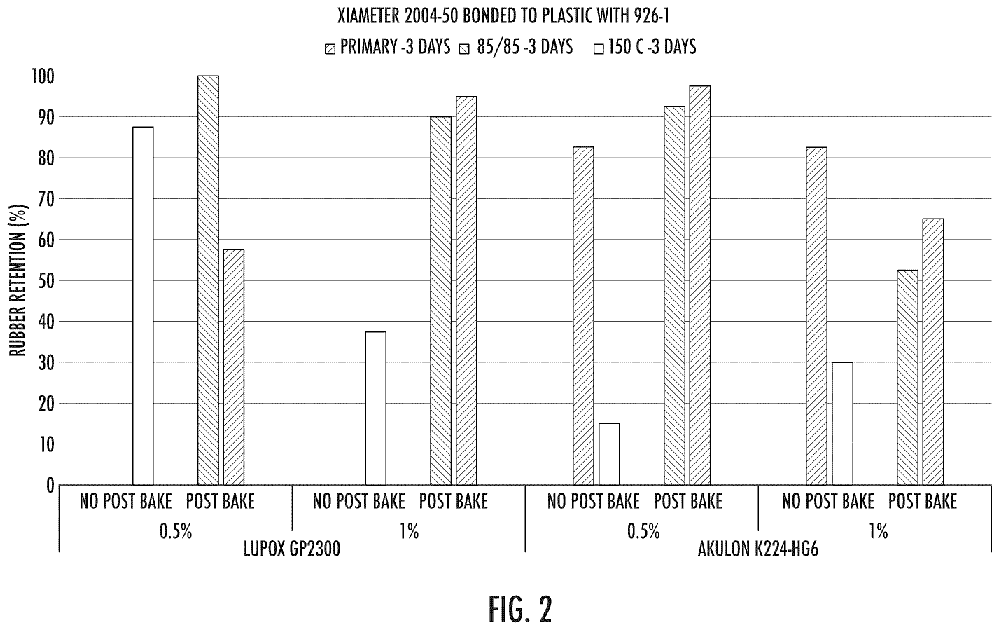

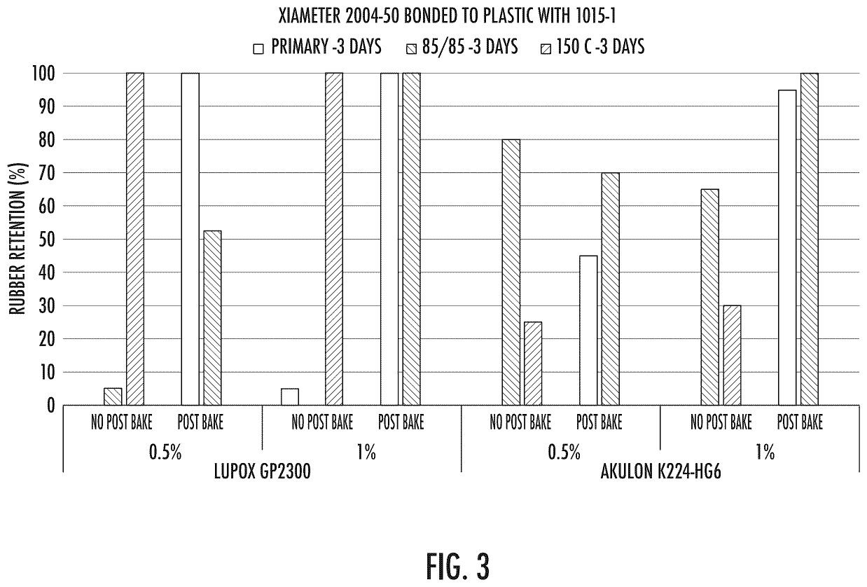

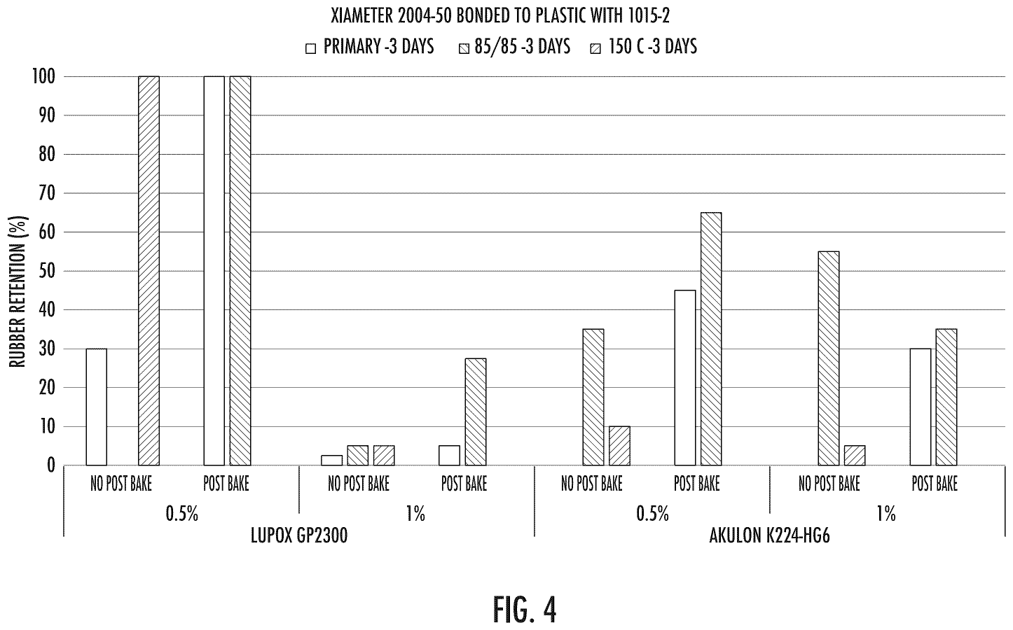

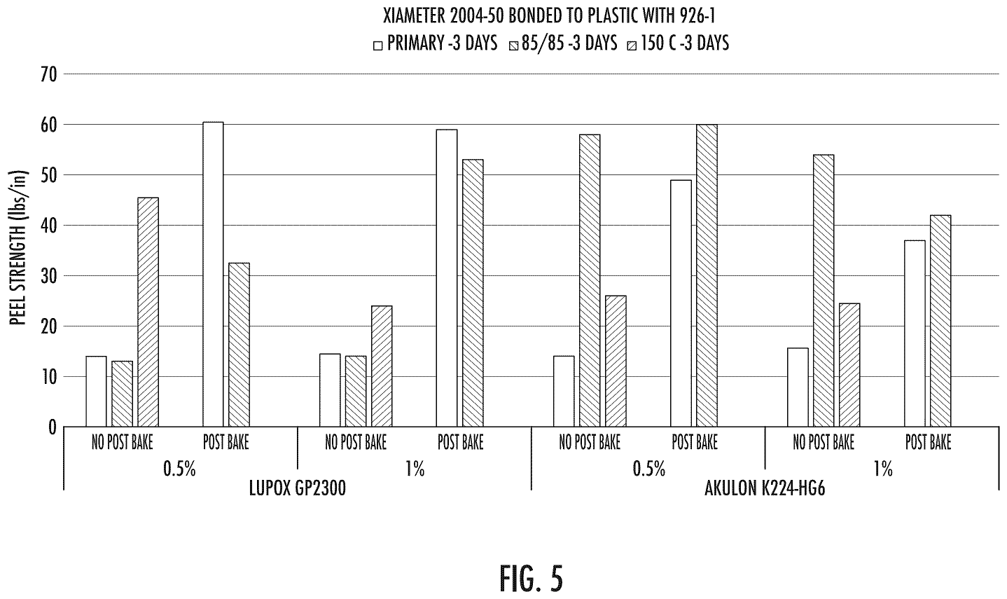

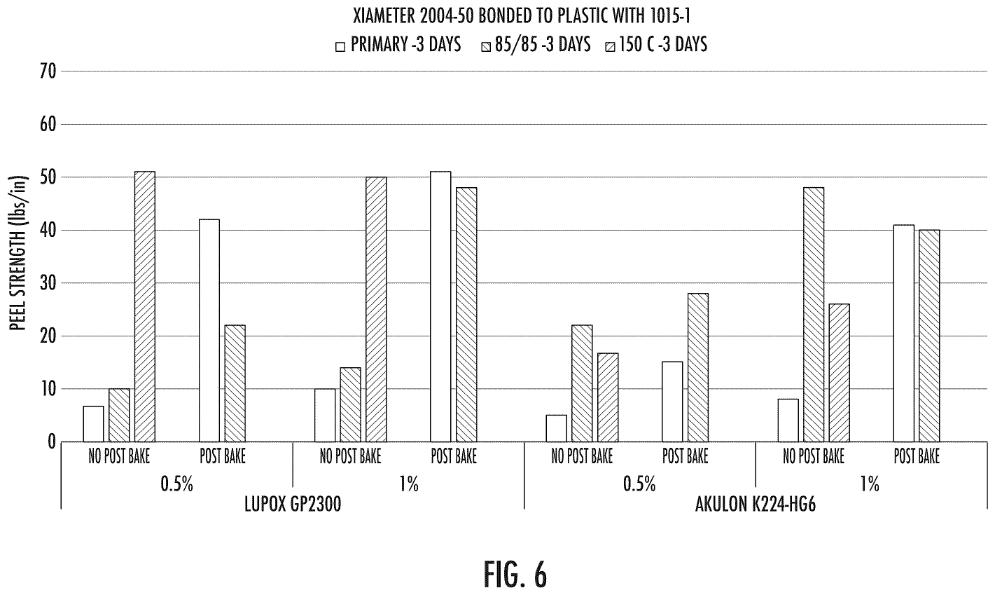

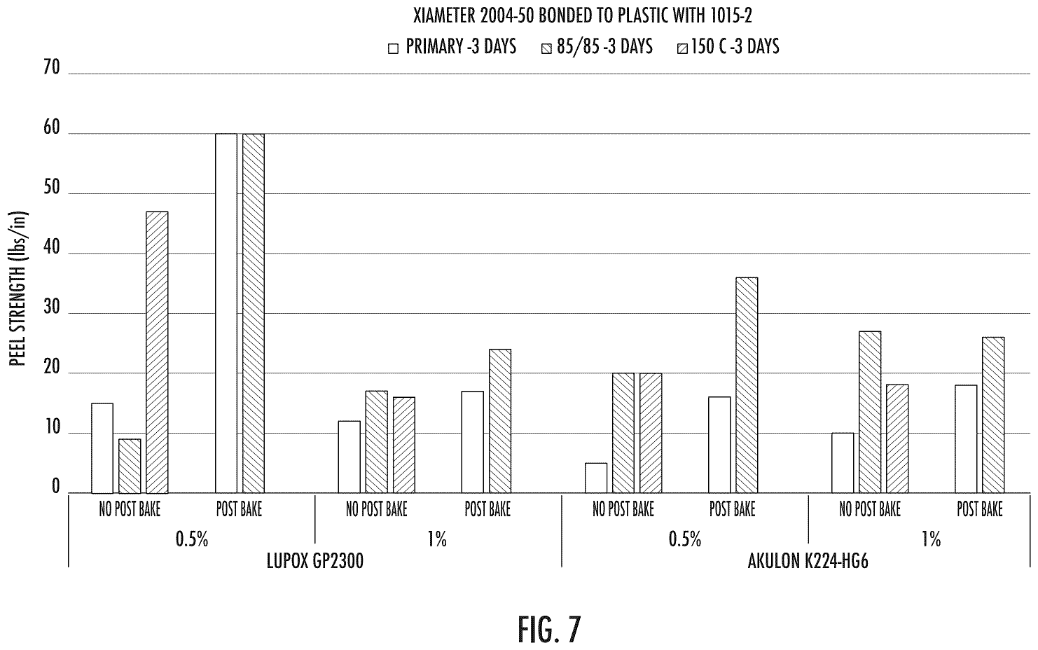

Adhesion modifier formulas are given in Table 4, below. All of the components are miscible liquids and were added together and stirred by hand to create a homogeneous liquid additive. These additives were then added via a pump to a LSR from Dow (i.e., XIAMETER™ RBL2004-50; Dow Corning Corporation, Midland, Michigan, United States of America), and specimens were injection molded onto plastic substrates. The plastic substrates used were a 30% glass filled PBT (i.e., Lupox® GP2300, produced by LG Chemical, Seoul, South Korea) and a 30% glass filled PA6 (i.e., AKULON™ K224-HG6, produced by DSM, Heerlen, The Netherlands). The additive package was added at 0.5% and 1.0% level. After molding, some of the coupons were post baked at 150° C. for 1 hour. The coupons were then aged in one of three environments: laboratory conditions (23° C./50% RH), hot air (150° C.), or 85° C./85% relative humidity (RH) for 3 days. Coupons were then tested for peel strength and rubber retention. The results below show strong bonding between the silicone and plastic can be achieved and the bonding survives exposure to 150° C. and 85° C./85% RH for 3 days. See FIGS. 2-7.

TABLE 4
Adhesion Modifier Compositions

| Experimental Code | 926-1 | Amount (g) |
|---|---|---|
| SiSiB HF2078 | 50.0% | 20.0 |
| Fumarate Silane | 15.0% | 6.0 |
| A187 Glycidoxypropyl Trimethoxy Silane | 15.0% | 6.0 |
| MQH-9 Resin | 20.0% | 8.0 |
| TOTAL | 100.0% | 40.0 |
| Experimental Code | 1015-1 | Amount (g) |
| SiSiB HF 2078 | 25.0% | 10.0 |
| SiSiB HF 2080 | 25.0% | 10.0 |
| Fumarate Silane | 15.0% | 6.0 |
| A187 Glycidoxypropyl Trimethoxy Silane | 15.0% | 6.0 |
| MQH-9 Resin | 20.0% | 8.0 |
| TOTAL | 100.0% | 40.0 |
| Experimental Code | 1015-2 | Amount (g) |
| SiSiB HF 2078 | 25.0% | 10.0 |
| HPM-502 | 25.0% | 10.0 |
| Fumarate Silane | 15.0% | 6.0 |
| A187 Glycidoxypropyl Trimethoxy Silane | 15.0% | 6.0 |
| MQH-9 Resin | 20.0% | 8.0 |
| TOTAL | 100.0% | 40.0 |

### Example 4

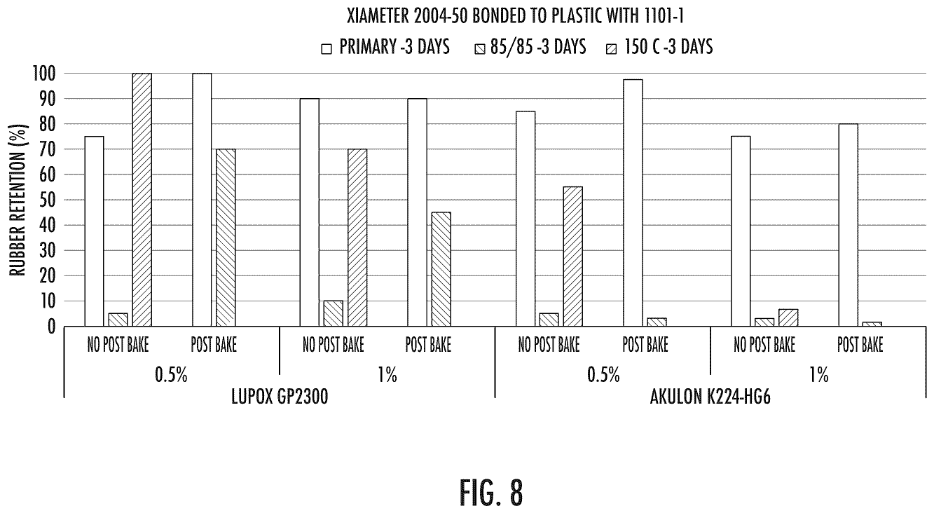

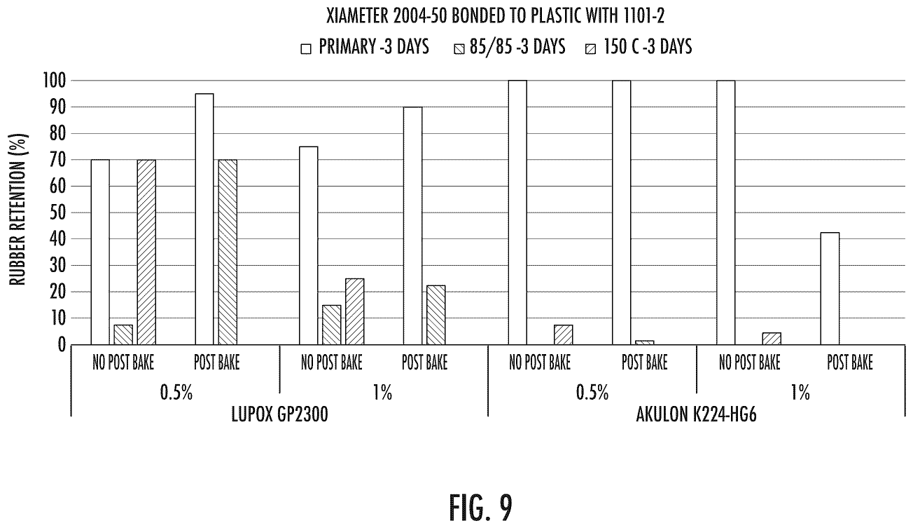

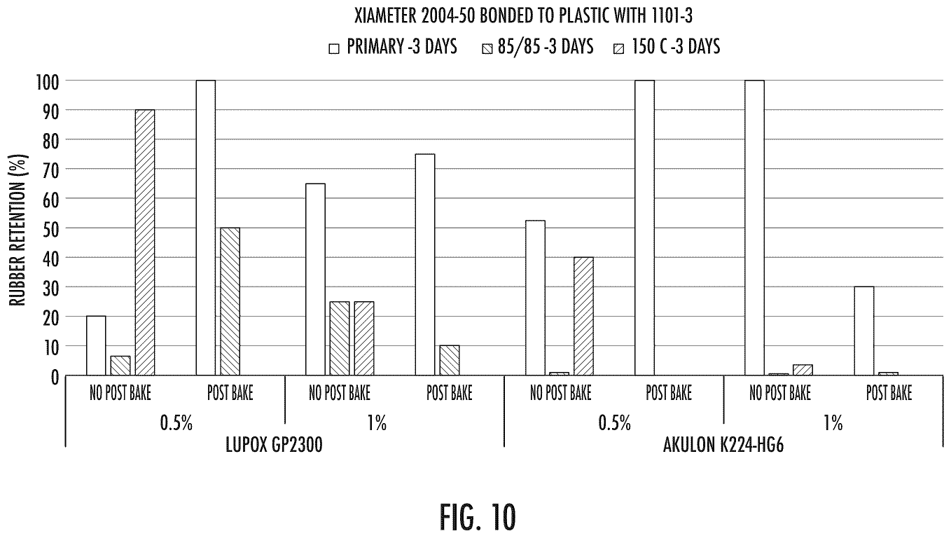

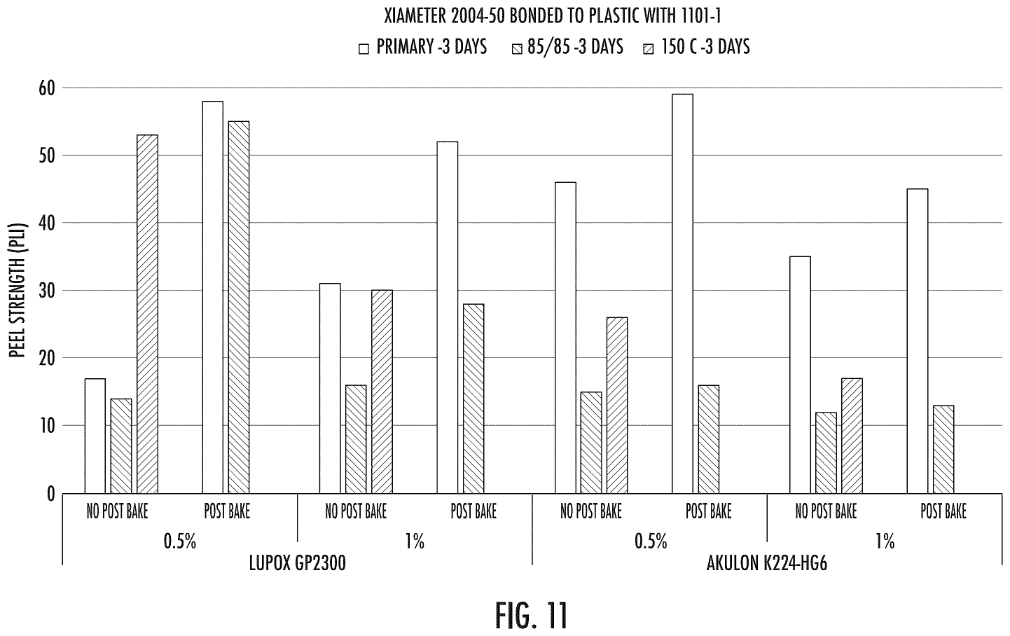

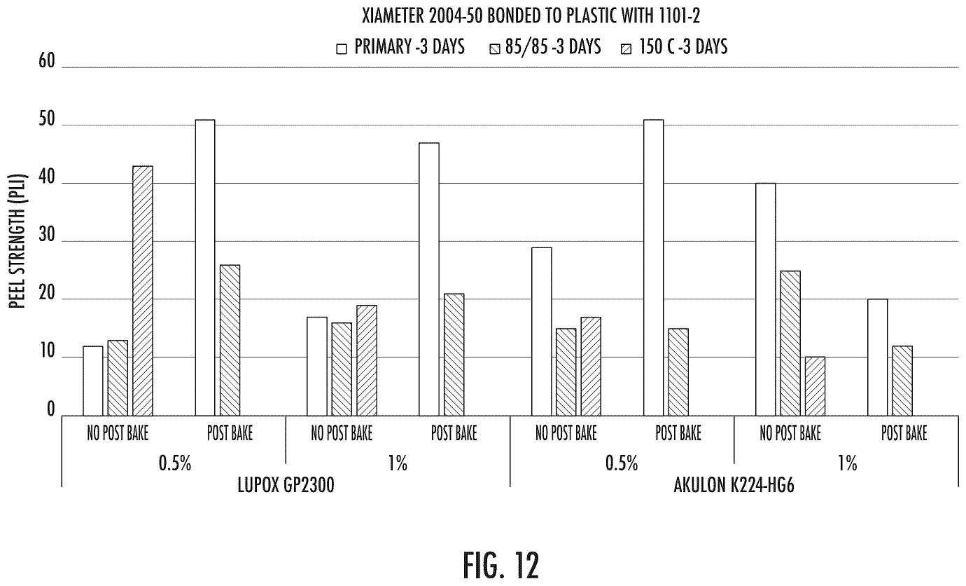

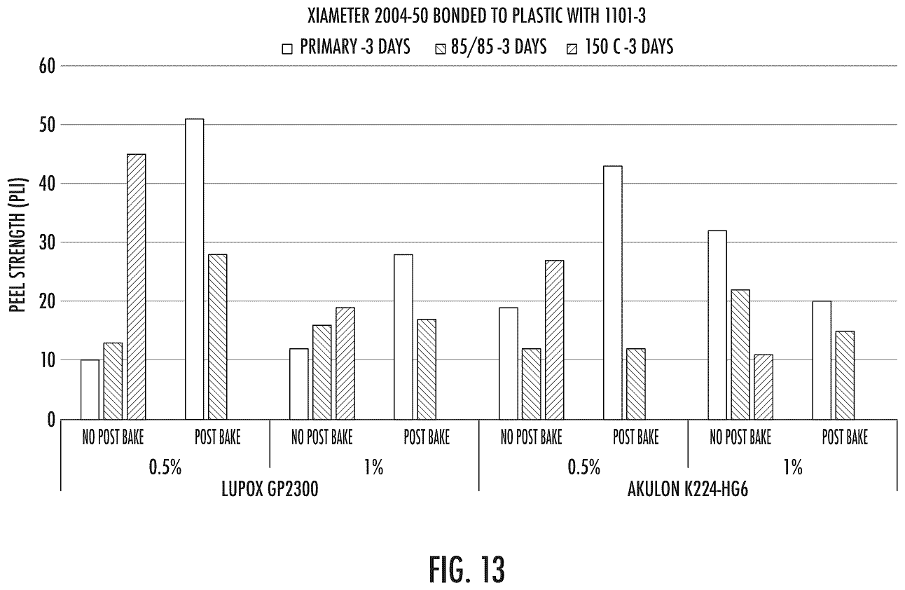

All conditions were the same as those from Example 3 with the exception of the adhesion modified formulas, which are given below in Table 5. The results show that further improvement to bonding can be achieved with the addition of a succinic anhydride-containing functional silane, which dramatically improves bond strength formation without the need for post baking. See FIGS. 8-13.

TABLE 5
Adhesion Modifier Compositions.

| Experimental Code | 1101-1 | Amount (g) |
|---|---|---|
| SiSiB HF 2078 | 20.0% | 8.0 |
| HPM-502 | 20.0% | 8.0 |
| Fumarate Silane | 15.0% | 6.0 |
| A187 Glycidoxypropyl Trimethoxy Silane | 15.0% | 6.0 |
| MQH-9 Resin | 15.0% | 6.0 |
| Succinic Silane | 15.0% | 6.0 |
| TOTAL | 100.0% | 40.0 |
| Experimental Code | 1101-2 | Amount (g) |
| SiSiB HF 2078 | 20.0% | 8.0 |
| SiSiB HF 2080 | 20.0% | 8.0 |
| Fumarate Silane | 15.0% | 6.0 |
| A187 Glycidoxypropyl Trimethoxy Silane | 15.0% | 6.0 |
| MQH-9 Resin | 15.0% | 6.0 |
| Succinic Silane | 15.0% | 6.0 |
| TOTAL | 100.0% | 40.0 |
| Experimental Code | 1101-3 | Amount (g) |
| SiSiB HF 2078 | 40.0% | 16.0 |
| Fumarate Silane | 15.0% | 6.0 |
| A187 Glycidoxypropyl Trimethoxy Silane | 15.0% | 6.0 |
| MQH-9 Resin | 15.0% | 6.0 |
| Succinic Silane | 15.0% | 6.0 |
| TOTAL | 100.0% | 40.0 |

### Example 5

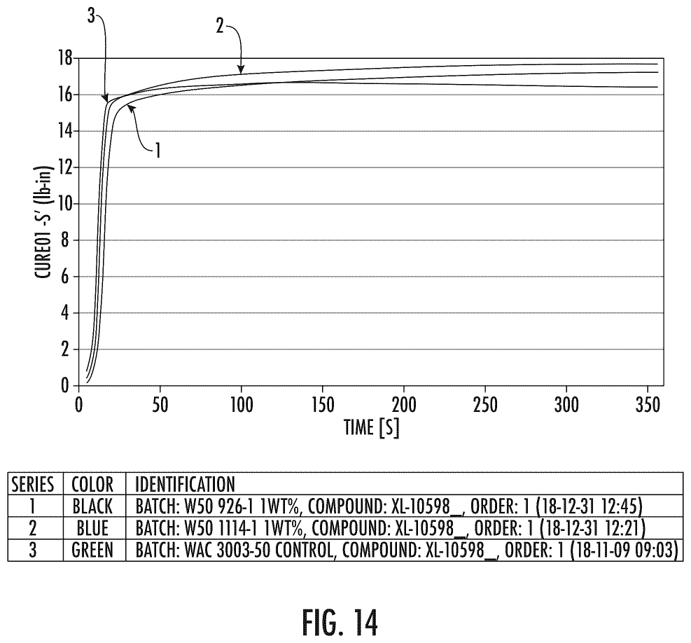

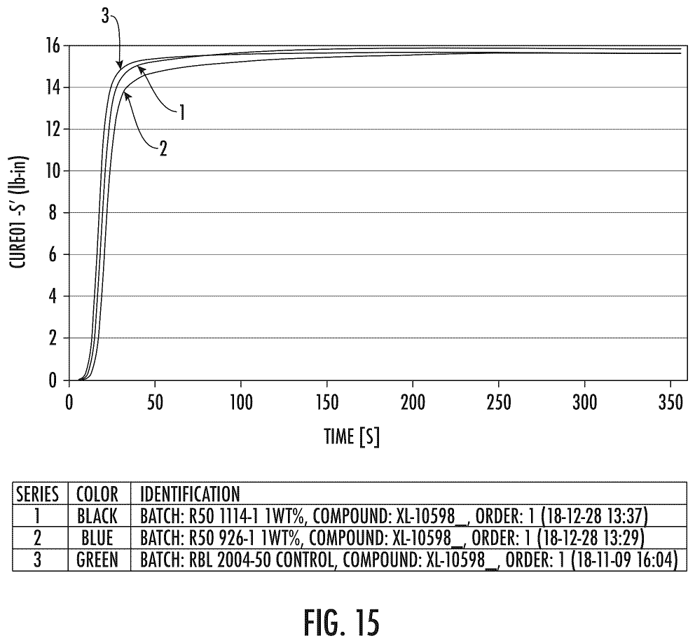

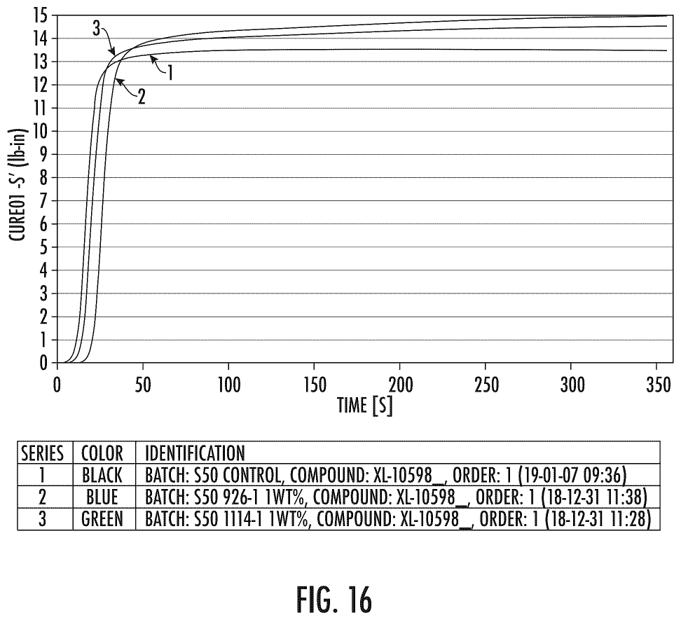

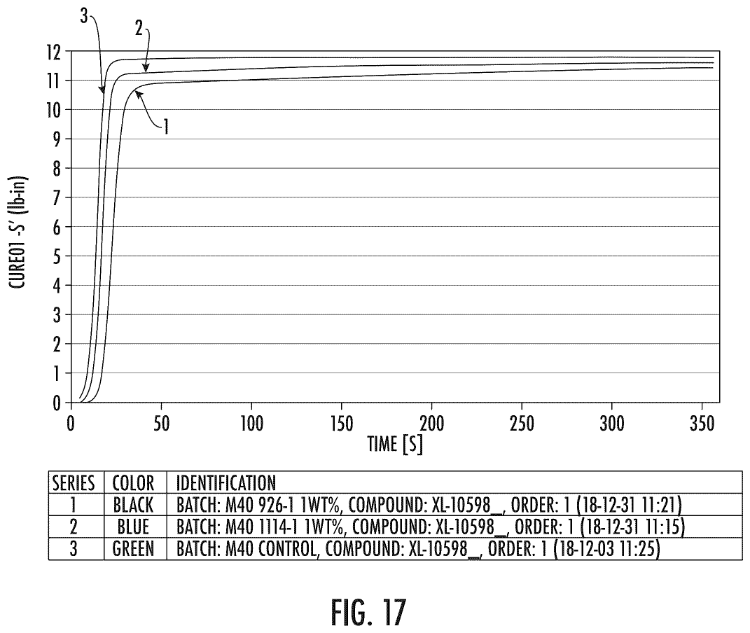

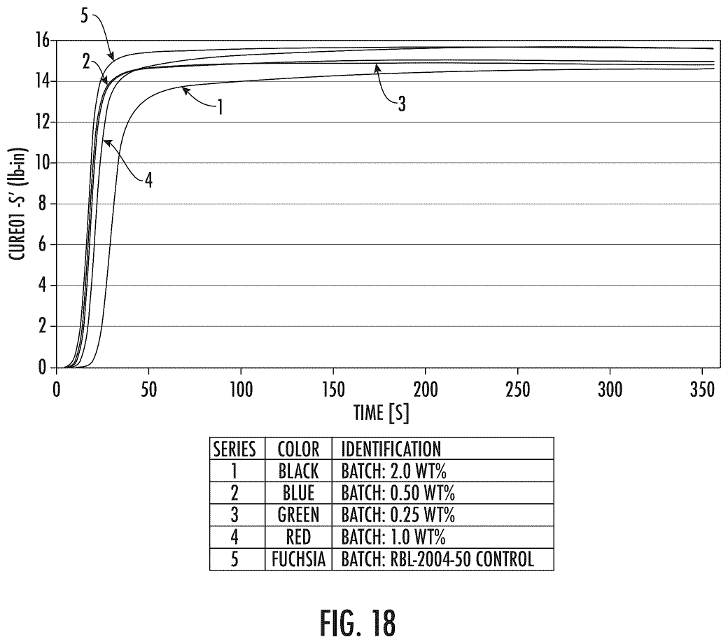

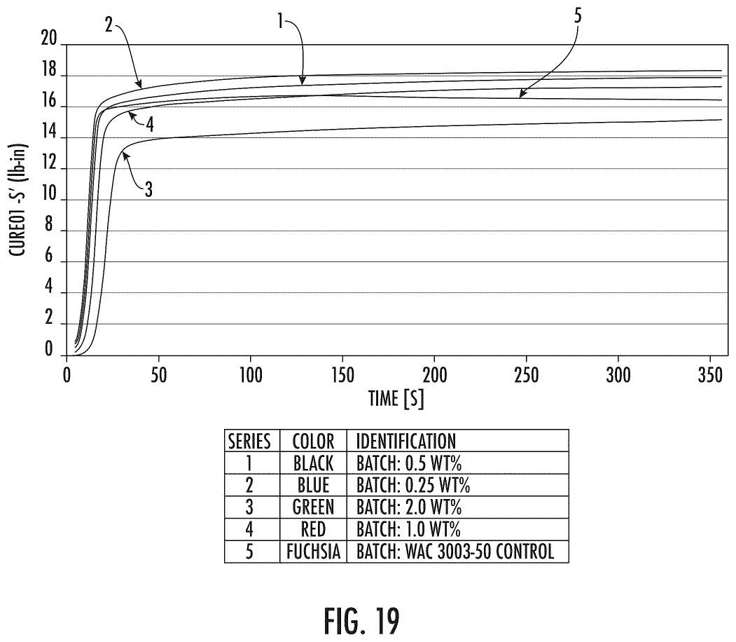

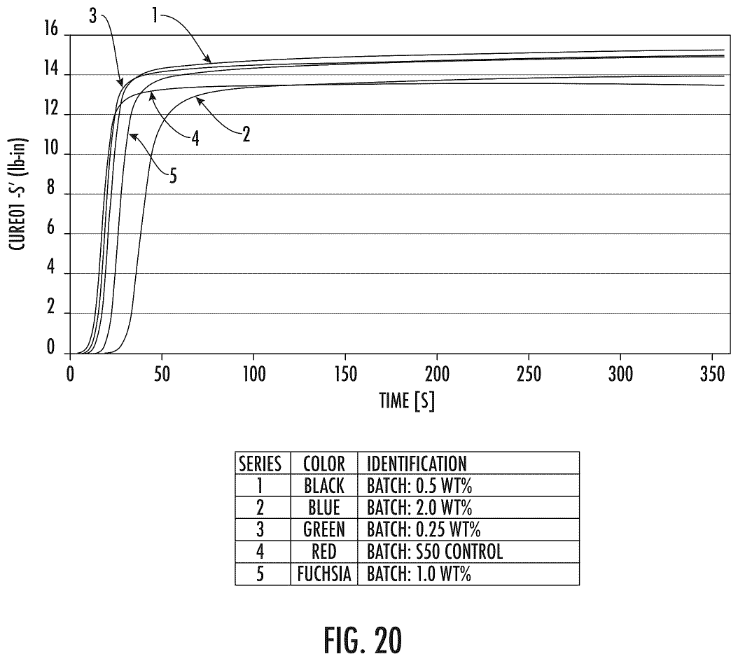

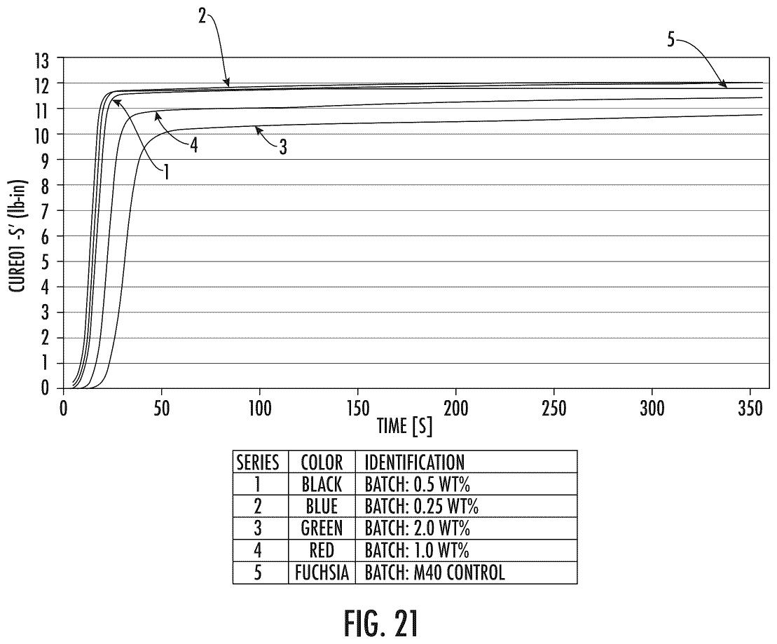

Silicon rubber compositions were modified with one of the two adhesion modifier compositions described in Table 6 and Table 11. One of the modifier compositions is the same as one of the compositions described above in Example 3, while the other also includes two additional components, a polydimethylsiloxane (PMX-200, 1000 cst) and silated silica (hexamethadisilazane (HMDS Silica)). The silicone rubber compositions modified included the following LSRs: Elastosil® 3003-50 (Wacker Chemie AG, Munich, Germany), XIAMETER™ 2004-50 (Dow Corning Corporation, Midland, Michigan, United States of America), SILOPREN™ 2640 (Momentive, Waterford, New York, United States of America), and KEG-2000-50A/B from Shin-Etsu Chemical Co. Ltd. (Tokyo, Japan). Physical properties of the different modified LSRs were measured and compared to the unmodified (control) LSRs. With the exception of the samples prepared using the LSR from Wacker, the following conditions were used:
Slab conditions: 10 minutes at 149° C. or 150° C.; post cure 15 minutes at 149° C. or 150° C.
Heat age conditions: 70 hours at 175° C.
Compression Set conditions: 22 hours at 175° C.
Rheology conditions: 6 minutes at 149° C. or 150° C.
   For the Wacker LSR-based samples, the conditions were:
Slab conditions: 10 minutes at 165° C.; post cure 15 minutes at 149° C.
Heat age conditions: 70 hours at 175° C.
Compression Set conditions: 22 hours at 175° C.
Rheology conditions: 6 minutes at 165° C.
   Durometer, tensile, elongation, and tear properties are are summarized below in Tables 7-10 and 12-15. Cure rheology results are shown in FIGS. 14-21.

TABLE 6
Adhesion Modifier Composition 1114-1.
1114-1

| Chemical (CAS) | Percentage |
|---|---|
| PMX-200 1000 cst | 43.8% |
| (63148-62-9) | |
| Sisib HF 2078 | 21.9% |
| (68952-30-7/925454-54-2) | |
| Fumarate Silane | 6.7% |
| (3371-62-8) | |
| 3-Glycidyloxypropyl | 6.7% |
| Trimethoxysilane | |
| (2530-83-8) | |
| MQH-9 Resin | 8.6% |
| (68988-57-8) | |
| HMDS Silica | 12.4% |
| (68909-20-6/7631-86-9) | |

TABLE 7
Property Data for Modified and Control Wacker LSR

| | | Heat Aged | 1114-1, | 1114-1, 1% wt, |
|---|---|---|---|---|
| Material | Control | Control | 1% wt | Heat Age |
| Hardness | 48 | 50 | 48 | 53 |
| Shore (A) | | | | |
| Tensile (psi) | 1332 | 1324 | 1437 | 1262 |
| Elongation (%) | 672 | 575 | 539 | 386 |
| Modulus@ | 167 | 200 | 214 | 289 |
| 100% (psi) | | | | |
| Tear (lbf/in) | 201 | 188 | 297 | 143 |
| Compression | 8.50% | | 39.60% | |
| Set (%) | | | | |

TABLE 8
Property Data for Modified and Control Dow LSR

| | | Heat Aged | 1114-1, | 1114-1, 1% wt, |
|---|---|---|---|---|
| Material | Control | Control | 1% wt | Heat Age |
| Hardness | 47 | 53 | 49 | 57 |
| Shore (A) | | | | |
| Tensile (psi) | 1250.02 | 1234 | 1317 | 1243 |
| Elongation (%) | 694 | 520 | 723 | 392 |
| Modulus @ | 215 | 332 | 258 | 385 |
| 100% (psi) | | | | |
| Tear (lbf/in) | 213 | 257 | 261 | 245 |
| Compression | 27% | | 17.50% | |
| Set (%) | | | | |

TABLE 9
Property Data for Modified and Control Shin Etsu LSR

| | | Heat Aged | 1114-1, | 1114-1, 1% wt, |
|---|---|---|---|---|
| Material | Control | Control | 1% wt | Heat Age |
| Hardness | 45 | 51 | 45 | 52 |
| Shore (A) | | | | |
| Tensile (psi) | 1358 | 1467 | 1403 | 1306 |
| Elongation (%) | 923 | 527 | 581 | 453 |
| Modulus @ | 183 | 240 | 194 | 250 |
| 100% (psi) | | | | |
| Tear (lbf/in) | 163 | 170 | 155 | 154 |

TABLE 10
Property Data for Modified and Control Momentive LSR

| | | Heat Aged | 1114-1, | 1114-1, 1% wt, |
|---|---|---|---|---|
| Material | Control | Control | 1% wt | Heat Age |
| Hardness | 38 | 43 | 39 | 47 |
| Shore (A) | | | | |
| Tensile (psi) | 1249 | 1095 | 1134 | 1190 |
| Elongation (%) | 635 | 519 | 654 | 514 |
| Modulus @ | 149 | 237 | 149 | 256 |
| 100% (psi) | | | | |
| Tear (lbf/in) | 149 | 235 | 205 | 247 |
| Compression | 38.90% | | 38.60% | |
| Set (%) | | | | |

TABLE 11
Adhesion Modifier Composition 926-1.
926-1

| Chemical (CAS) | Percentage |
|---|---|
| Sisib HF 2078 | 50% |
| (68952-30-7/925454-54-2) | |
| Fumarate Silane | 15% |
| (3371-62-8) | |
| 3-Glycidyloxypropyl | 15% |
| Trimethoxysilane | |
| (2530-83-8) | |
| MQH-9 Resin | 20% |
| (68988-57-8) | |

TABLE 12
Property Data for Modified and Control Dow LSR.

| | | | | 926-1 | | 926-1 | | 926-1 | | 926-1 |
|---|---|---|---|---|---|---|---|---|---|---|
| | | | | 0.25 | | 0.50 | | 1.0 | | 2.0 |
| | | Control, | 926-1 | wt %, | 926-1 | wt %, | 926-1 | wt %, | 926-1 | wt %, |
| | | Heat | 0.25 | Heat | 0.50 | Heat | 1.0 | Heat | 2.0 | Heat |
| Material | Control | Aged | wt % | Aged | wt % | Aged | wt % | Aged | wt % | Aged |
| Durometer | 47 | 53 | 47 | 55 | 48 | 56 | 51 | 60 | 50 | 60 |
| (Shore A) | | | | | | | | | | |
| Tensile (psi) | 1250 | 1234 | 1370 | 1321 | 1478 | 1384 | 1437 | 1246 | 1370 | 1377 |
| Elongation | 694 | 520 | 680 | 538 | 695 | 529 | 646 | 354 | 643 | 479 |
| (%) | | | | | | | | | | |
| Modulus @ | 215 | 332 | 235 | 326 | 247 | 358 | 264 | 415 | 248 | 399 |
| 100% (psi) | | | | | | | | | | |
| Tear (lbf/in) | 216 | 257 | 249 | 254 | 261 | 277 | 248 | 248 | 268 | 270 |
| Compression | 27% | | 26% | | 25% | | 25% | | 43% | |
| Set (%) | | | | | | | | | | |

TABLE 13
Property Data for Modified and Control Wacker LSR.

| | | | | 926-1 | | 926-1 | | 926-1 | | 926-1 |
|---|---|---|---|---|---|---|---|---|---|---|
| | | | | 0.25 | | 0.50 | | 1.0 | | 2.0 |
| | | Control, | 926-1 | wt %, | 926-1 | wt %, | 926-1 | wt %, | 926-1 | wt %, |
| | | Heat | 0.25 | Heat | 0.50 | Heat | 1.0 | Heat | 2.0 | Heat |
| Material | Control | Aged | wt % | Aged | wt % | Aged | wt % | Aged | wt % | Aged |
| Durometer | 48 | 50 | 49 | 53 | 49 | 54 | 48 | 55 | 47 | 56 |
| (Shore A) | | | | | | | | | | |
| Tensile (psi) | 1332 | 1324 | 1366 | 1222 | 1441 | 1024 | 1400 | 1230 | 1505 | 1509 |
| Elongation | 672 | 575 | 531 | 393 | 560 | 348 | 535 | 387 | 590 | 487 |
| (%) | | | | | | | | | | |
| Modulus @ | 167 | 200 | 224 | 284 | 208 | 286 | 204 | 272 | 179 | 282 |
| 100% (psi) | | | | | | | | | | |
| Tear (lbf/in) | 201 | 188 | 136 | 239 | 269 | 237 | 138 | 157 | 141 | 143 |
| Compression | 9% | | 42% | | 46% | | 46% | | 48% | |
| Set (%) | | | | | | | | | | |

TABLE 14
Property Data for Modified and Control Shin-Etsu LSR.

| | | | | 926-1 | | 926-1 | | 926-1 | | 926-1 |
|---|---|---|---|---|---|---|---|---|---|---|
| | | | | 0.25 | | 0.50 | | 1.0 | | 2.0 |
| | | Control, | 926-1 | wt %, | 926-1 | wt %, | 926-1 | wt %, | 926-1 | wt %, |
| | | Heat | 0.25 | Heat | 0.50 | Heat | 1.0 | Heat | 2.0 | Heat |
| Material | Control | Aged | wt % | Aged | wt % | Aged | wt % | Aged | wt % | Aged |
| Durometer | 45 | 51 | 45 | 52 | 46 | 52 | 46 | 53 | 45 | 56 |
| (Shore A) | | | | | | | | | | |
| Tensile (psi) | 1390 | 1467 | 1510 | 1548 | 1487 | 1569 | 1548 | 1197 | 1532 | 1446 |
| Elongation | 830 | 527 | 671 | 539 | 641 | 532 | 643 | 414 | 663 | 485 |
| (%) | | | | | | | | | | |
| Modulus @ | 184 | 240 | 176 | 284 | 181 | 252 | 175 | 260 | 171 | 266 |
| 100% (psi) | | | | | | | | | | |
| Tear (lbf/in) | 163 | 170 | 160 | 172 | 162 | 170 | 152 | 159 | 163 | 161 |
| Compression | 53% | | 57% | | 60% | | 37% | | 63% | |
| Set (%) | | | | | | | | | | |

TABLE 15
Property Data for Modified and Control Momentive LSR.

| | | | | 926-1 | | 926-1 | | 926-1 | | 926-1 |
|---|---|---|---|---|---|---|---|---|---|---|
| | | | | 0.25 | | 0.50 | | 1.0 | | 2.0 |
| | | Control, | 926-1 | wt %, | 926-1 | wt %, | 926-1 | wt %, | 926-1 | wt %, |
| | | Heat | 0.25 | Heat | 0.50 | Heat | 1.0 | Heat | 2.0 | Heat |
| Material | Control | Aged | wt % | Aged | wt % | Aged | wt % | Aged | wt % | Aged |
| Durometer | 38 | 43 | 39 | 46 | 38 | 47 | 39 | 49 | 39 | 51 |
| (Shore A) | | | | | | | | | | |
| Tensile (psi) | 1122 | 1095 | 1036 | 1106 | 1119 | 1162 | 1220 | 1157 | 1188 | 1268 |
| Elongation | 588 | 519 | 629 | 542 | 659 | 553 | 683 | 490 | 736 | 557 |
| (%) | | | | | | | | | | |
| Modulus @ | 149 | 237 | 149 | 238 | 151 | 242 | 149 | 279 | 145 | 287 |
| 100% (psi) | | | | | | | | | | |
| Tear (lbf/in) | 149 | 235 | 280 | 208 | 219 | 224 | 139 | 234 | 153 | 233 |
| Compression | 39% | | 38% | | 42% | | 44% | | 59% | |
| Set (%) | | | | | | | | | | |

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A modified curable silicone rubber composition comprising an adhesion modifier composition, the adhesion modifier composition comprising:
(a) at least one alkoxy silane comprising an alkoxy silane with a functional group selected from an ester and an anhydride group;
(b) at least one diffusion promoter, wherein the diffusion promoter is a polyphenylmethylsiloxane that is completely or partially immiscible in dimethylsilicone, wherein the at least one diffusion promoter comprises at least one functional diffusion promoter, wherein the functional diffusion promoter is a hydride-functional polyphenylmethylsiloxane that is completely or partially immiscible in dimethylsilicone; and
(c) at least one cure modifier, wherein the at least one cure modifier is a compound comprising a —Si—H group;
wherein the adhesion modifier composition comprises between 0.25% and 2.0% of a total weight of the modified curable silicone rubber composition.

2. The modified curable silicone rubber composition of claim 1, wherein the at least one alkoxy silane includes at least one alkoxy silane further comprising a functional group selected from the group consisting of an ester of fumaric acid, an ester of succinic acid, and an anhydride of succinic acid.

3. The modified curable silicone rubber composition of claim 1, wherein the at least one alkoxy silane is selected from the group consisting of glycidoxypropyl trimethoxy silane, bis(3-trimethoxysilylpropyl) fumarate, and (3-triethoxysilyl)propylsuccinic anhydride.

4. The modified curable silicone rubber composition of claim 1, wherein the adhesion modifier comprises at least two alkoxy silanes.

5. The modified curable silicone rubber composition of claim 1, wherein the at least one diffusion promoter is hydride-functional methylphenylpolysiloxane selected from the group consisting of a hydride-functional polyphenylmethylsiloxane, a hydride-functional polyphenyl(dimethylhydrosiloxy)siloxane, and a hydride-functional (methylhydrosiloxane)-phenymethylsiloxane copolymer.

6. The modified curable silicone rubber composition of claim 1, wherein the at least one cure modifier is selected from the group consisting of a hydride Q resin, a hydride-functional polydimethyl siloxane, and a hydride-functional (dimethylsiloxane)-phenylmethylsiloxane copolymer.

7. The modified curable silicone rubber composition of claim 1, where the composition comprises between about 15% by weight to about 50% by weight of the at least one functional silane, between about 19% by weight and about 70% by weight of the at least one diffusion promoter, and between about 15% by weight and about 45% by weight of the at least one cure modifier.

8. The modified curable silicone rubber composition of claim 1, further comprising a zinc-containing transesterification catalyst-further optionally wherein the transesterification catalyst comprises about 1% by weight of the total adhesion modifier composition.

9. The modified curable silicone rubber composition of claim 1, wherein the transesterification catalyst comprises titanium alkoxide at about 0.1% to about 0.5% by weight of the total adhesion modifier composition.

10. The modified curable silicone rubber of claim 1, further comprising one or more additional components, optionally selected from the group consisting of a polydimethylsiloxane and a silica.

11. The modified curable silicone rubber composition of claim 1, further comprising:
a curable organopolysiloxane composition that can be cured to provide a silicone rubber.

12. The modified curable silicone rubber composition of claim 11, wherein the curable organopolysiloxane composition is a composition that can be heat cured to provide a liquid silicone rubber (LSR), a high consistency rubber (HCR), or a room temperature vulcanized (RTV) silicone.

13. The modified curable silicone rubber composition of claim 11, wherein the curable organopolysiloxane composition comprises:
(i) an organopolysiloxane polymer having a viscosity of about 1,000 to about 10,000,000 centipoises at 25° C. and comprising silicon-bonded alkyl substituents having reactivity with an organohydrogenpolysiloxane crosslinker, optionally wherein the silicon-bonded alkyl groups are silicon-bonded vinyl groups;
(ii) about 0.3 to about 40 parts by weight of the organohydrogenpolysiloxane crosslinker containing at least two silicon-bonded hydrogens per molecule;
(iii) a catalytically effective amount of a platinum group metal catalyst; and
(iv) about 0.01 to about 3 parts by weight of a cure inhibitor, optionally wherein the cure inhibitor is an acetylene alcohol derivative.
